(19) United States
(12) Patent Application Publication
(10) Pub. No.: US 2018/0187426 A1
(43) Pub. Date: Jul. 5, 2018

(54) DEVICE FOR SMOOTHING AND/OR FLOATING

(71) Applicant: NELA GMBH, Remscheid (DE)

(72) Inventors: FRANK FREUDENREICH, REMSCHEID (DE); DIRK NEDDERMANN, WUPPERTAL (DE)

(21) Appl. No.: 15/738,569

(22) PCT Filed: Jun. 17, 2016
(86) PCT No.: PCT/DE2016/100275

§ 371 Date: Dec. 20, 2017

(30) Foreign Application Priority Data
Jun. 22, 2015 (DE) 10 2015 007 891.7

(51) Int. Cl. E04F 21/16; B08B 1/00

(52) U.S. Cl. CPC E04F 21/161; B08B 1/005

(57) ABSTRACT

The invention relates to a device (100) for smoothing and/or floating and/or spreading filler compounds or plaster compounds, comprising a smoothing and/or filler plate (1) and a handle (2) connected to the smoothing and/or filler plate (1), wherein the smoothing and/or filler plate (1) has a working surface and a fastening side (4) lying opposite the working surface for the handle. The aim of the invention is that handle and trowel plate are at least partially glued together by an intermediate element, which should confer a long service life to the device. This is achieved in that the smoothing and/or filler plate (1) is glued to the handle by means of an intermediate element with the aid of an adhesive (11), wherein a sealing (12) is arranged between the intermediate element and the smoothing and/or filler plate (1).

### TECHNICAL FIELD

The invention relates to a device according to claim 1.

Such tools, in particular, smoothing trowels, are used in construction, in order to plaster walls with a plaster compound or to apply other materials to other surfaces.

Smoothing trowels consist of a trowel bade, a handle and one or several elements for fastening the trowel blade with the handle.

If an intermediate plate or another element is glued to the trowel blade in order to fasten the handle, then it can happen that the water contained in the plaster medium attacks the adhesive, or that the intermediate plate is detached from the trowel blade with time. The tool must also be cleaned after use, for which water is also used, in order to dissolve the plaster compound from the tool before the latter dries up hard. This water can also attack the adhesive.

### PRIOR ART

A smoothing trowel is shown and described, for example, in DE 29922317 U1. This trowel consists essentially of a handle, a smoothing plate made of metal and a connection part, which is fastened to the handle and the smoothing plate and holds the handle and the smoothing plate together.

Another smoothing trowel with an intermediate plate is known from DE 20 2005 018 687 U1. This smoothing trowel is a spreading and smoothing tool for masonry, plasterers, tilers as well as parquet and floor layers. The trowel comprises a handle, a support, a web and an exchangeable trowel blade. An intermediate plate is arranged on the web, which is clamped in an exchangeable frame provided with elastic clamping webs.

### PROBLEM ADDRESSED BY THE INVENTION

The problem addressed by the invention is to create a device for smoothing with a handle and a trowel blade, or a smoothing and/or or filling plate, in which the handle and the trowel blade are at least partially glued together by an intermediate element, so that the device has a long service life.

### SOLUTION AND ADVANTAGES OF THE INVENTION

This problem is solved by a device with the features indicated in the claim.

The invention is based on the realization that foamed acrylate adhesives react very sensitively to plaster material, since the alkaline material withdraws moisture from the adhesive material and thus reduces its adhesive effect.

Also, other adhesives can act as a sponge, so that penetrating water or moisture can damage the adhesive layer. A contact of the adhesive, which holds the smoothing plate, with the plaster compound must in any case be prevented.

As a result of the sealing according to the present invention it is easily prevented that the effect of the adhesive diminishes with time and the intermediate element is detached from the trowel blade. The cleaning water or the alkaline material of the plaster compound is effectively kept away from the adhesive by the sealing according to the present invention.

The use of the adhesive creates a very firm connection of the handle and the smoothing plate by means of the intermediate element, wherein the production costs can be reduced.

The sealing acts as a seal, which prevents a penetration of water and moisture or alkaline material into the adhesive zone. Thus, a protective layer quasi arises for the adhesive.

The device according to the present invention for smoothing and/or filling and/or for spreading filler compounds or plaster compounds is a hand tool, in particular, a smoothing trowel. This comprises a smoothing and/or or filling plate or a smoothing blade as well as a handle connected with the smoothing blade. The smoothing blade has a working surface and a fastening side opposite the working surface for the handle in the known manner. The smoothing blade is glued indirectly with the handle by an intermediate element with an adhesive, whereby welded connections are avoided directly on the smoothing blade. The sealing is arranged according to the present invention between the intermediate element and the smoothing blade.

The sealing can be designed as a UV weather-resistant seal.

The sealing is a water-resistant or waterproof means.

A sealing is arranged at the edge between the intermediate element and the smoothing and/or filling plate.

### ADVANTAGEOUS EMBODIMENTS OF THE INVENTION AND FURTHER ADVANTAGES

Further advantageous embodiments of the invention are characterized in the dependent claims.

In an advantageous further development of the device according to the present invention it is provided that the sealing is designed as a sealing circumferentially about the intermediate element. Thus, a closed seal arises with which the adhesive is protected from all sides. Additional seals are not required. The sealing or the sealing means can be applied in a single manufacturing step with an O-movement or be designed in the form of a film.

It is particularly advantageous if the intermediate element is designed flat or comprises at least one flat section. Thus, a relatively large adhesive surface exists, which ensures a very firm connection of the handle to the plate or to the trowel blade.

In the case of a further advantageous design of the invention the intermediate element is designed as a connecting plate. The connecting plate is smaller than the trowel blade. Thus, a thickness of the trowel blade is quasi increased, which ensures a certain reinforcement in the middle of the blade and facilitates a welding of the bolt, wherein, however, the edges of the trowel blade are flexible, which facilitates the work with the smoothing trowel.

It is very advantageous, if the adhesive is an acrylate adhesive, in particular, a foamed acrylate adhesive. Acrylate adhesives ensure an extremely firm connection and glue quickly.

A particularly preferable further development of the invention is characterized in that the sealing material of the sealing is designed as a paste or a means similar to paste, wherein the sealing, in particular, comprises a material, which is designed on the basis of silane-modified polymers. The paste can be applied very precisely and dries relatively quickly. Commercially available products can be readily used. After drying the paste has a high degree of hardness and is very tension-resistant, so that it cannot be damaged. Thus, the smoothing trowel has a very long service life and can be promoted on the market as a quality product.

It is optimal if after the drying process the sealing material has a hardness of at least 20 shore A, in particular, approximately 30 shore A and in particular has a tensile strength of at least 0.5 MPa, in particular, approximately 1 MPa. Such values can be easily attained with commercially available products and are desirable for tools of the trade for professional use, for example, in construction.

It is very advantageous, if the sealing is a film, in particular, a self-adhesive film made of plastic. This can be flat and relatively wide and seal well. The film can be easily mounted and not be damaged during work.

In order to achieve, on the one hand, an easy manufacture and, on the other hand, an optimal protection against moisture, it is provided according to a further advantageous embodiment, that the sealing overlaps the smoothing and/or or filling plate and the intermediate element with at least several millimeters, wherein the sealing has a height of approximately 0.3 mm to 3 mm. The application can occur by hand or by machine. A paste can be applied with commercially available bottles or tubes. A film can be taken from a roll.

In an advantageous further development of the hand-held tool according to the present invention it is provided, that fastening bolts are arranged on the fastening side, wherein each bolt, on the one hand, is firmly connected directly with the intermediate element and, on the other hand, is connected directly with the fastening flange through a press-fit connection, wherein the fastening flange has a handle fastening section, and wherein the fastening flange has several openings or boreholes, into which the fastening bolts protrude. The bolts can be welded on the intermediate plate and be pressed-fitted on the fastening flange. Such a connection has turned out have a very long-lasting service life.

A design as a smoothing trowel or as a filler, in particular as a surface filler, preferably squeegee, or as a painter's scraper is advantageous.

### EMBODIMENTS

Embodiments are elucidated in detail by means of the drawings, wherein several advantageous further developments of the invention and advantages of the same are described.

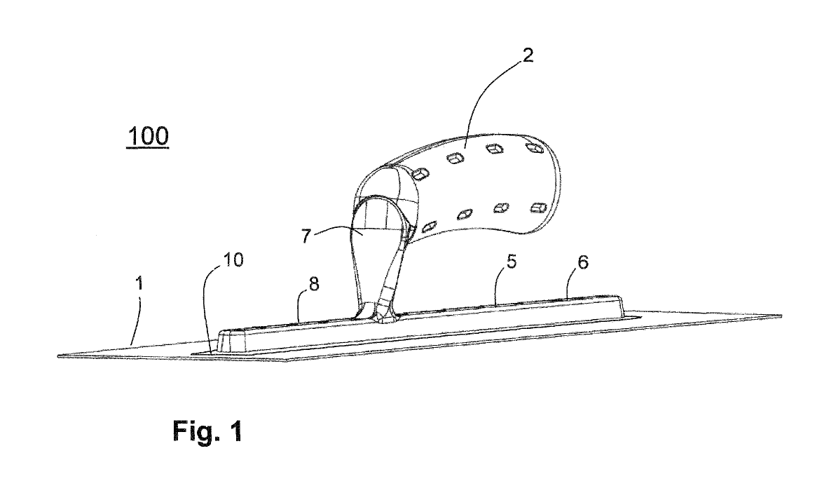

FIG. 1 shows a perspective representation of a smoothing trowel according to the present invention,

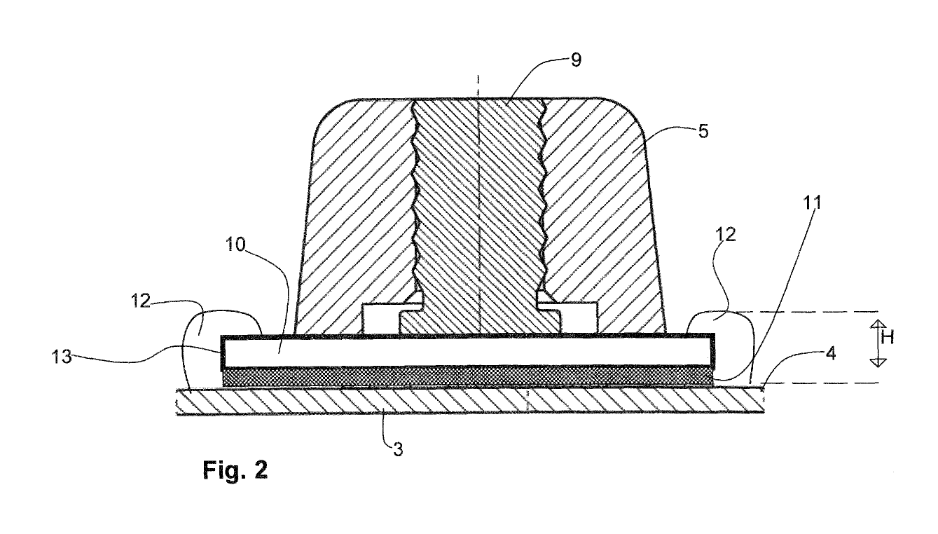

FIG. 2 shows a sectional representation of the smoothing trowel,

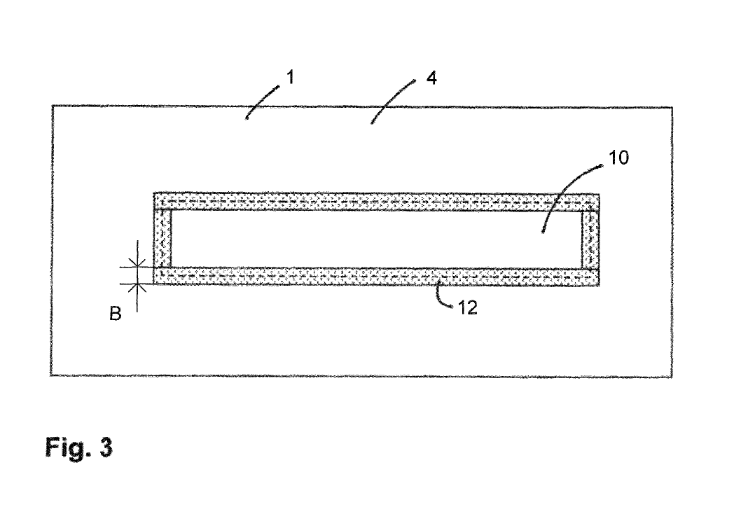

FIG. 3 shows a representation of the upper side of the smoothing trowel, however, without handle,

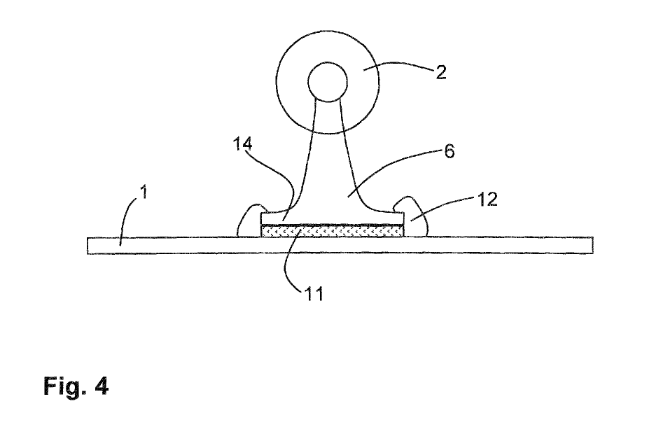

FIG. 4 shows a representation of the smoothing trowel from the front,

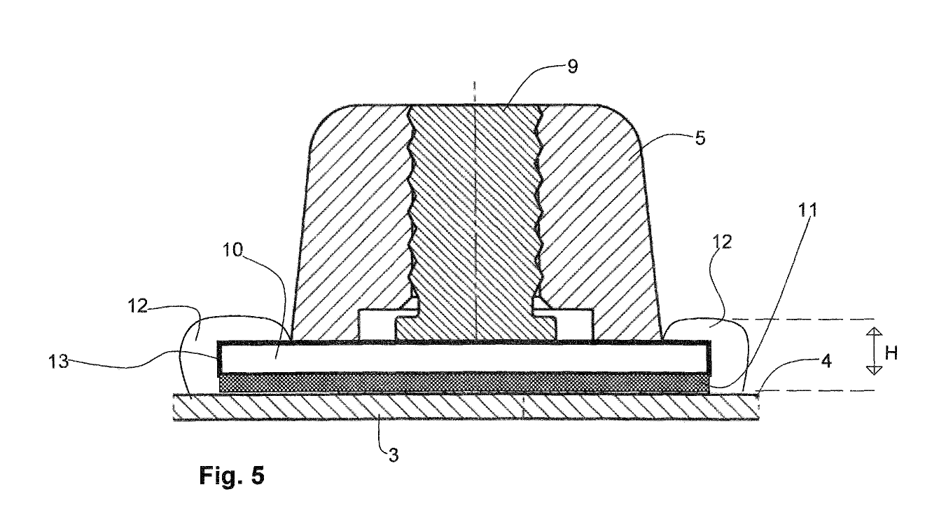

FIG. 5 shows a representation of a variant of the smoothing trowel,

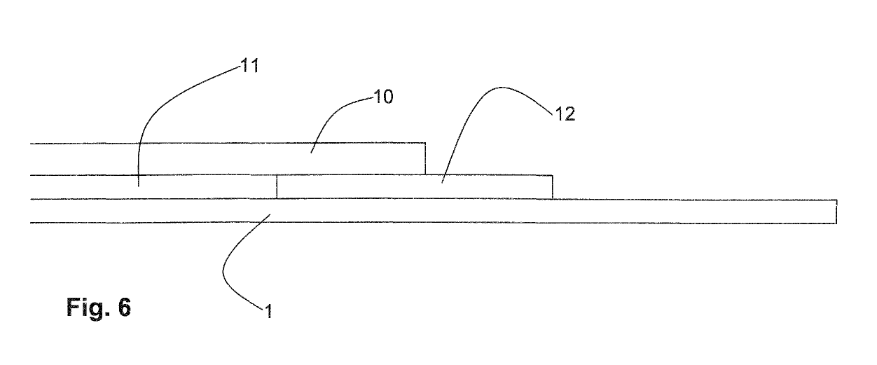

FIG. 6 shows a sectional representation of an edge region of an intermediate plate,

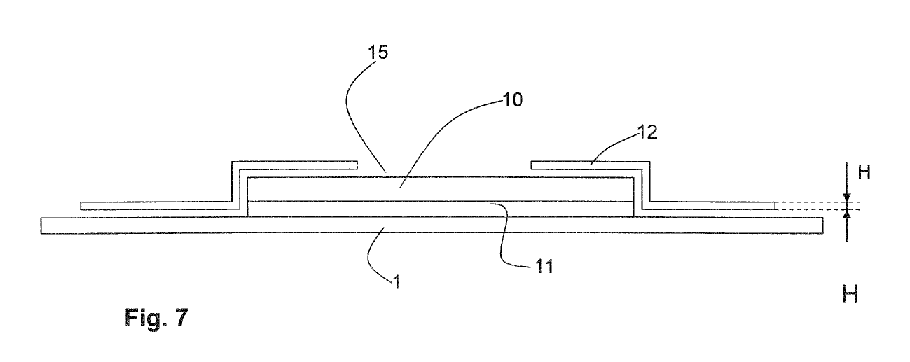

FIG. 7 shows a sectional representation of the embodiment of the smoothing trowel analogous to FIG. 5, wherein a film, which is pulled apart, is shown,

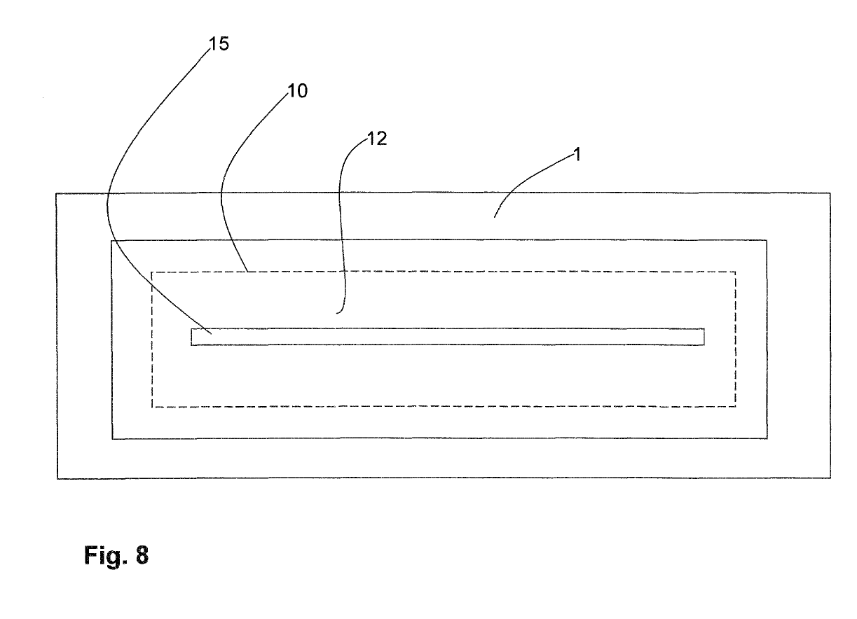

FIG. 8 shows a representation of the embodiment according to FIG. 6 from above, and

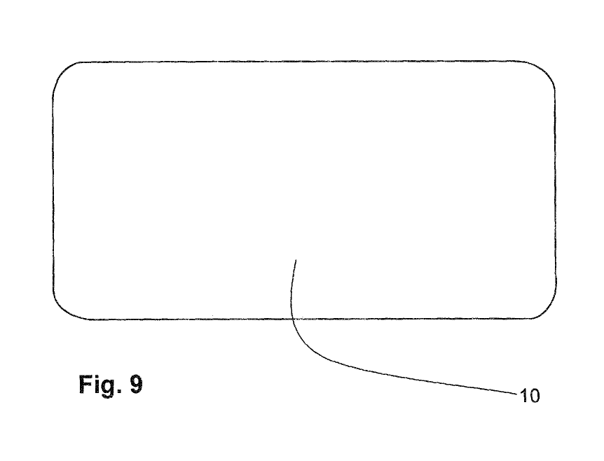

FIG. 9 shows an embodiment of an intermediate plate.

FIG. 1 shows a device 100 for smoothing plaster compounds, specifically a smoothing trowel. The smoothing trowel comprises a smoothing plate 1 as well as a handle 2 connected with the smoothing plate 1. The smoothing plate 1 consists of metal. The handle 2 can consist of cork, wood or plastic.

The smoothing plate 1 or the smoothing blade comprises a working side 3, which is characterized in FIG. 2 or a working surface. The smoothing plate 1 is approximately 0.2 mm to 0.55 thick, preferably approximately 0.3 mm thick and thus flexible, which is advantageous for certain work.

The side opposite the working surface is a fastening side 4 for the handle 2. Furthermore, the device 100 is provided with a holding element 5 connecting the handle 2 and the smoothing plate 1 to the fastening side 4, which is shown sectioned in FIG. 2. The holding element 5 has a fastening flange 6 for fastening the smoothing plate 1 and has a handle fastening section 7, as shown in FIG. 1.

The fastening flange 6 has a plurality of openings or boreholes 8, in which in each case, as FIG. 2 shows, protruding fastening bolts 9 on the smoothing plate protrude. Each bolt 9 is only indirectly connected firmly with the smoothing plate 1 and, on the other hand, is directly connected with the fastening flange 6 by a press-fit connection, as FIG. 2 illustrates.

As FIG. 2 shows, an intermediate element, namely an intermediate plate 10 is arranged between the fastening side 4 of the smoothing plate 1 and the fastening flange 6 connected with the handle 2. The bolt 9 is connected directly with the intermediate plate 10, wherein the intermediate plate 10 is connected directly to the smoothing plate 1 with an adhesive 11, as FIG. 2 shows. The intermediate element is designed as a connecting plate.

The intermediate plate 10 is thicker than the smoothing plate 1, which permits a welding of the bolts 9. A material, which is too thin would warp during the welding and assume an undesired corrugated form. The intermediate plate 10 is approximately 0.6 mm to 1 mm, preferably approximately 0.7 mm thick.

The smoothing plate 1 is glued with an adhesive together with the handle by an intermediate element. A sealing 12 is arranged between the intermediate plate 10 and the smoothing plate 1, as FIG. 2 illustrates. The adhesive 11 is located quasi underneath the intermediate plate 10. The sealing 12 is arranged on the edge 13 of the intermediate plate 10.

In FIG. 3 the intermediate plate 10 is displayed as dashed. The sealing 12 is designed as a sealing 12 circumferentially about the intermediate element 10.

The intermediate plate 10 can have a length of, for example, 10 cm to 30 cm and a width of 4 cm to 10 cm. The intermediate plate 10 is smaller than the plate 1, as FIG. 3 shows, and has at most a third of the surface area of plate 1.

The intermediate element is designed flat and need not be designed as a separate part. It can also be integrally formed with a fastening flange 6′. FIG. 4 shows an embodiment, in which the fastening flange 6′ comprises at least one flat section 14. The fastening flange 6′ can be produced as a pressure die-cast part made of metal.

The adhesive 11 is an acrylate adhesive or a foamed acrylate adhesive. The adhesive 11 can be a pressure-sensitive adhesive film or an acrylic-foam adhesive tape.

The sealing material of the sealing 12 is designed, for example, as a paste, wherein he sealing comprises, in particular, a material, which is designed on the basis of silane-modified polymers. For example, TEROSON MS 930 also known as TEROSTAT MS 930 can be used.

After a drying process, the sealing material has, for example, a hardness of at least 20 shore A, in particular, approximately 30 shore A and, in particular, has a tensile strength of at least 0.5 MPa, in particular, approximately 1 MPa. The sealing 12 is permanently elastic.

As FIGS. 2 and 3 show, the sealing overlaps the smoothing and/or or filling plate with at least several millimeters. The sealing width B is approximately 3 to 10 mm. The sealing has a height H of approximately 1 to 3 mm.

In FIG. 2 it is good to see that the fastening bolts 9 are arranged on the fastening side 4, wherein each bolt, on the one hand, is firmly connected directly with the intermediate plate 10 and, on the other hand, is directly connected with the fastening flange 6 by a press-fit connection, wherein the fastening flange 6 has a handle fastening section 7, and wherein the fastening flange 6 has the openings 8 or boreholes, in which the fastening bolts 9 protrude.

In FIG. 5 a variant of the smoothing trowel is shown. In this embodiment the sealing 12 extends up to the fastening flange 6, so that a sealing occurs also in the area of the fastening flange 6.

The adhesive 11 can be an acrylate adhesive or a foamed acrylate adhesive. The adhesive 11 can be a pressure-sensitive adhesive film or an acrylic-foam adhesive tape. For example, GT 6008 of the 3M firm can be used.

The adhesive tape is approximately 0.2 to 1.3 mm thick, in particular, approximately 0.6 mm thick.

The adhesive tape can consist of a relatively thick foam material, such as of the type 4930 of the 3M firm. It has been established that the thickness of the adhesive tape is important.

An adhesive tape of the type 4646 of the firm 3M® can also be used.

The adhesive tape can be a double tape, such as UHU® 75 kg or UHU 125 kg extreme.

As FIG. 6 illustrates the adhesive tape can be smaller or narrower than the intermediate plate 10, so that a distance exists of the adhesive tape or of another adhesive means to the edge of the intermediate plate 10 of approximately 5 mm to 15 mm, in particular, approximately 10 mm. The sealing 12 is arranged in part underneath the plate 10 and above the plate 1 and abuts flat against both plates 1, 10.

FIG. 7 and FIG. 8 illustrate a variant, in which the sealing 12 is designed as thin film with a thickness of 0.025 mm to 0.1 mm. The film is glued together with the intermediate plate 10 and the smoothing plate 1. The film can be a double-sided self-adhesive film. The film can be a plastic film and/or an aluminum-vaporized film with advantageous design. The film has a recess 15 corresponding to the form of a fastening flange 6. The handle 2 or the fastening flange 6 is fastened after the adhesion of the film. The film sealing 12 is permanently elastic and tear-resistant.

The adhesive 11 can be used in combination with a primer tackifier. The tackifier can be applied on one or both sides or both plates 10 and 1.

FIG. 9 shows that it is advantageous, if the corners of the intermediate plate 10 are provided with a radius of 2 mm to 15 mm, in particular, approximately 8 mm to 10 mm. Thus, a high adhesive power is produced at the corners.

The invention is not limited to these examples. Thus, the tool can also be a filler or a surface filler, squeegee, or painter's scraper or another tool for applying and polishing plasters and fillers of suitable hand tool, for example, for floor, parquet or tile layers.

Instead of the described paste or film, a powder which is meltable by heat exposure or another water-resistant means, for example, in liquid form, can be used. The sealing can also be sprayed on. Also, multiple-component means can also be used. The sealing can also be a water-resistant adhesive.

The fastening of handle 2 and smoothing plate 1 need not, as stated, be achieved with a fastening flange 6 or several bolts 9. This fastening can be achieved with nearly all of the methods known from the prior art.

An acrylic adhesive or a two-component adhesive or epoxy adhesive can be used as an adhesive.

A silicon adhesive from the sanitary sector can also serve as sealing.

A sealing is arranged between the intermediate element and the smoothing and/or filling plate. This means that the sealing can have any arrangement, in which an infiltration of the adhesive by filling material is prevented.

Each feature of an example shown and/or described can be combined with another feature shown and/or described. Thus, the feature shown in FIG. 6 of the distance of the adhesive film of 10 mm to the intermediate plate edge can be combined with a film according to FIG. 7.

### LIST OF REFERENCE SIGNS

100 device
1 smoothing plate
2 handle
3 smoothing side
4 fastening side
5 holding element
6 fastening flange
7 handle fastening section
8 boreholes
9 bolt
10 intermediate plate
11 adhesive
2 sealing
13 edge
14 flat section
15 recess

1. A device (100) for smoothing and/or filling and/or for spreading filler compounds or plaster compounds, comprising a smoothing and/or a filling plate (1) as well as a handle (2) connected with the smoothing and/or filling plate (1), wherein the smoothing and/or or filling plate (1) has a working surface and a fastening side (4) opposite the working surface for the handle, wherein the smoothing and/or filling plate (1) is glued with an adhesive (11) together with the handle by an intermediate element, and wherein a sealing (12) is arranged between the intermediate element and the smoothing and/or filling plate (1).

2. A device according to claim 1, characterized in that the sealing (12) is designed as a sealing (12) circumferential about the intermediate element.

3. A device according to claim 1, characterized in that the intermediate element is designed flat or comprises at least one flat section (14).

4. A device according to claim 1, characterized in that the intermediate element is designed as a connecting plate.

5. A device according to claim 1, characterized in that the adhesive (11) is an acrylate adhesive, in particular, a foamed acrylate adhesive.

6. A device according to claim 1, characterized in that the sealing material of the sealing (12) is designed as a paste, wherein the sealing (12) comprises, in particular, a material, which is designed on the basis of silane-modified polymers.

7. A device according to claim 1, characterized in that the sealing material is a film.

8. A device according to claim 1, characterized in that the sealing (12) overlaps the smoothing and/or or filling plate and the intermediate element with at least several millimeters, wherein the sealing (12) has a height of 0.3 mm to 3 mm.

9. A device according to claim 1, characterized in that fastening bolts are arranged on the fastening side, wherein each bolt (9), on the one hand, is directly connected firmly with the intermediate element and, on the other hand, is directly connected with a fastening flange (6) by a press-fit connection, wherein the fastening flange (6) has a handle fastening section, and wherein the fastening flange (6) has several openings or boreholes (8) into which the fastening bolts protrude.

10. A device according to claim 1, characterized by a design as a smoothing trowel or as a filler, in particular, as a surface filler, preferably as a squeegee, or as a painter's scraper.

11. A device according to claim 2, characterized in that the intermediate element is designed flat or comprises at least one flat section (14).

12. A device according to claim 2, characterized in that the adhesive (11) is an acrylate adhesive, in particular, a foamed acrylate adhesive.

13. A device according to claim 3, characterized in that the adhesive (11) is an acrylate adhesive, in particular, a foamed acrylate adhesive.

14. A device according to claim 4, characterized in that the adhesive (11) is an acrylate adhesive, in particular, a foamed acrylate adhesive.

15. A device according to claim 11, characterized in that the adhesive (11) is an acrylate adhesive, in particular, a foamed acrylate adhesive.

16. A device according to claim 2, characterized in that the sealing material of the sealing (12) is designed as a paste, wherein the sealing (12) comprises, in particular, a material, which is designed on the basis of silane-modified polymers.

17. A device according to claim 3, characterized in that the sealing material of the sealing (12) is designed as a paste, wherein the sealing (12) comprises, in particular, a material, which is designed on the basis of silane-modified polymers.

18. A device according to claim 4, characterized in that the sealing material of the sealing (12) is designed as a paste, wherein the sealing (12) comprises, in particular, a material, which is designed on the basis of silane-modified polymers.

19. A device according to claim 5, characterized in that the sealing material of the sealing (12) is designed as a paste, wherein the sealing (12) comprises, in particular, a material, which is designed on the basis of silane-modified polymers.

20. A device according to claim 11, characterized in that the sealing material of the sealing (12) is designed as a paste, wherein the sealing (12) comprises, in particular, a material, which is designed on the basis of silane-modified polymers.
